(19) United States
(12) Patent Application Publication
(10) Pub. No.: US 2017/0206220 A1
(43) Pub. Date: Jul. 20, 2017

(54) METHOD AND APPARATUS FOR UNIFIED DATA ACCESS ACROSS NETWORKED COMPUTERS

(71) Applicant: 1 DIGITAL INC., Taipei City (TW)

(72) Inventor: ZHEN-CHAO HONG, Taipei City (TW)

(21) Appl. No.: 15/001,304

(22) Filed: Jan. 20, 2016

(51) Int. Cl. G06F 17/30; H04L 29/08

(52) U.S. Cl. CPC G06F 17/30174; G06F 17/30117; G06F 17/30377; G06F 17/30109; G06F 17/3012; H04L 67/1078

(57) ABSTRACT

A method operating on a communication device for synchronizing data stored in the communication device with data stored in at least one device, comprising: logging in a server with a user account; generating metadata items for files stored in the communication device; obtaining from the server a list of the at least one device which logs in the server with the user account; obtaining from the server a notification indicating an anchor; exchanging data with each of the at least one device through a peer-to-peer connection while the communication device is designated as the anchor; and exchanging data with the anchor through a peer-to-peer connection while one of the at least one device is designated as the anchor.

### TECHNICAL FIELD

The present disclosure generally relates to the field of synchronizing data across multiple devices, and more specifically, to a method and apparatus for synchronizing data across multiple devices via peer-to-peer connection.

### BACKGROUND

Nowadays, it is common for a person to have multiple computing devices. These computing devices usually have a storage medium for storing files or data. Also, these computing devices usually can connect to the Internet or communicate with other devices using wired or wireless technology. Examples of these computing devices are smart phones, personal digital assistants (PDA), tablets, and notebooks. Managing or synchronizing the files in these computing devices could be a problem.

One of the commonly-used synchronization methods is to synchronize files across multiple computing devices through a cloud server. For this kind of synchronization, a user must upload all his files onto the cloud server. Therefore, the cloud server will have a database that contains all the files belonging to the user.

However, there are some drawbacks in this synchronization method. First of all, storing personal files on a cloud server that the user has no control of oftentimes raises privacy concerns. Secondly, operating a cloud server capable of storing large amount of users files is complex and expensive. As a result, users often need to pay a premium to keep the files on the server, or they will be at risk of losing all their files. This is clearly not an ideal way for long-term safekeeping of personal data. Therefore, there is a need to provide a method that can alleviate the above-mentioned drawbacks.

### SUMMARY

The embodiments of the present disclosure provide a method implemented on a communication device for synchronizing data stored in the communication device with that stored in one or more other devices. The method comprises logging in a server with a user account; generating at least one metadata item for at least one file stored in the communication device; obtaining from the server a list of the device(s) logged in the server with the user account; obtaining from the server a notification indicating an anchor among the communication device and the one or more other devices; and, if the communication device is designated as the anchor, exchanging data with each of the one or more other devices through a peer-to-peer connection so as to ensure that the communication device and the one or more other devices share the same metadata items. The method further comprises exchanging data with the anchor through a peer-to-peer connection if one of the one or more other devices is designated as the anchor, so as to ensure that the communication device and the anchor share the same metadata items. By doing so, the communication device and the one or more other devices may share their data in an anchor-based fashion. Since the anchor is also a device owned by the user, there is no security or privacy risk.

### BRIEF DESCRIPTION OF THE DRAWINGS

Aspects of the present disclosure are best understood from the following detailed description when read with the accompanying figures.

FIG. 1 illustrates communication devices for conducting peer-to-peer file synchronization according to an embodiment of the present disclosure.

FIG. 2 illustrates communication devices for conducting peer-to-peer file synchronization according to another embodiment of the present disclosure.

FIGS. 3A and 3B illustrate a flow chart of a method implemented on a communication device for conducting peer-to-peer file synchronization according to another embodiment of the present disclosure.

FIGS. 4A-4C illustrate a flow chart of a method implemented on a communication device for conducting peer-to-peer file synchronization according to another embodiment of the present disclosure.

FIG. 5 illustrates a flow chart for displaying and accessing files on a communication device according to another embodiment of the present disclosure.

FIG. 6 illustrates a flow chart of file synchronization initiated by changes in the files in a communication device according to another embodiment of the present disclosure.

FIGS. 7A-7D illustrate a preferred embodiment of peer-to-peer file synchronization across multiple devices through a photo album application.

FIGS. 8A and 8B illustrate another preferred embodiment of peer-to-peer file synchronization across multiple devices through a photo album application, wherein one of the devices is a black box.

### DETAILED DESCRIPTION

The following disclosure provides many different embodiments, or examples, for implementing different features of the present disclosure. Specific examples of components and arrangements are described below to simplify the present disclosure. These are, of course, merely examples and are not intended to be limiting. In addition, the present disclosure may repeat reference numerals and/or letters in the various examples. This repetition is for the purpose of simplicity and clarity and does not in itself dictate a relationship between the various embodiments and/or configurations discussed.

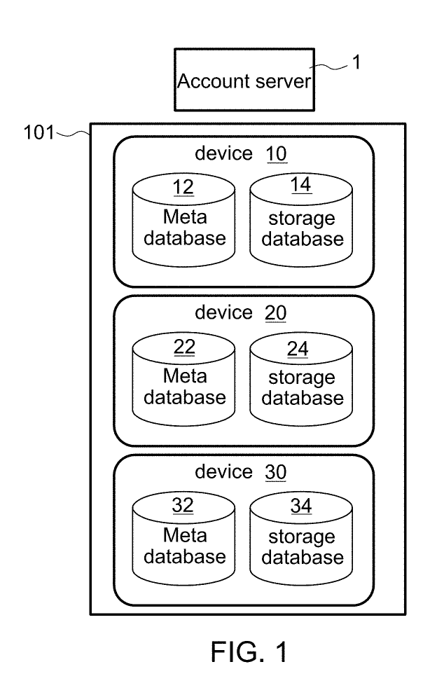

FIG. 1 illustrates communication devices for conducting peer-to-peer file synchronization according to an embodiment of the present disclosure. As shown in FIG. 1, a user 101 may use multiple electronic devices for business, personal or other uses. The electronic devices used by the user 101 in FIG. 1 are devices 10, 20, and 30. Each of devices 10, 20 and 30 may be, for example, a smart phone, a laptop, a tablet, or any other network-enabled device.

In a preferred embodiment of the present disclosure, a method for synchronization across devices 10, 20 and 30 in an anchor-based fashion is disclosed. First of all, a user 101 creates an account on the account server 1. Before synchronization across devices 10, 20 and 30 takes place, the account needs to be logged in on each of devices 10, 20 and 30, so as to ensure that they all belong to the user 101. The account server 1 only keeps the account information of the user 101, and the files stored in devices 10, 20 and 30 will not be uploaded to the account server 1.

One of devices 10, 20 and 30 will be designated by the account server 1 as the anchor. The synchronization across devices 10, 20 and 30 will be anchor-based. For example, if device 10 is designated as the anchor, devices 20 and 30 will synchronize with device 10 so that device 10 will be the device having the most up-to-date files or the most up-to-date information among the three devices. After synchronization, the anchor will notify the other two devices whether any data in the anchor has been updated. If any data in the anchor has been updated, the other two devices may update their data accordingly.

In another preferred embodiment of the present disclosure, each of devices 10, 20 and 30 has two databases. One is a meta database 12, 22 and 32, and the other one is a storage database 14, 24 and 34. The storage databases 14, 24 and 34 of devices 10, 20 and 30 comprise information about the actual locations of the files stored on devices 10, 20 and 30. When the user 101 needs to access any particular file, the actual location of that file can be found in one of the storage databases 14, 24 and 34. The Meta databases 12, 22 and 32 of devices 10, 20 and 30 comprise a plurality of metadata items regarding files that can be found in the storage databases 14, 24 and 34.

Usually, one metadata item corresponds to one single file. A metadata item comprises information such as the file size, the path of the file, the time and date on which the file was created, the time of last modification, and the hash value of the file. The hash value of a file can be used for identifying the file. A hash value can be generated using several well-known hash functions. These hash functions include, for example, MD5, SHA-1 (Secure Hash Algorithm 1) and SHA-256 (Secure Hash Algorithm 256). If the file is a photo, the metadata item may further comprise information such as the resolution of the photo, tags of the photo, the location where the photo was taken, a thumbnail picture of the photo, and whether the photo is marked as favorite.

The metadata items in meta databases 12, 22 and 32 are initially generated based on the files stored in storage databases 14, 24 and 34. According to a preferred embodiment, the metadata items (rather than files) stored in devices 10, 20 and 30 may be exchanged during synchronization. For example, after device 20 is logged in the account server 1, the account server sends a notification indicating device 10 as the anchor and a list of the other devices (i.e., devices 10 and 30) logged in with the same user account. Then, synchronization takes place between the meta databases 12 and 22 of devices 10 and 20 so that device 20 maintains a list of the metadata items corresponding to the files stored in all the devices of the user 101. Therefore, a list of the files stored in all the devices of the user 101 can be displayed on device 20 for the user 101's review even if some files are not stored in device 20. If the user 101 wishes to use device 20 to display a file that is not stored in device 20, device 20 may send a request to each of the devices logged in with the same user account for downloading that file. Upon receipt of the request, device 30 will check its storage database 34. If the check indicates that the requested file is in storage database 34, device 30 will send the file to device 20; otherwise, device 30 will send a reply indicating that the requested file is not available.

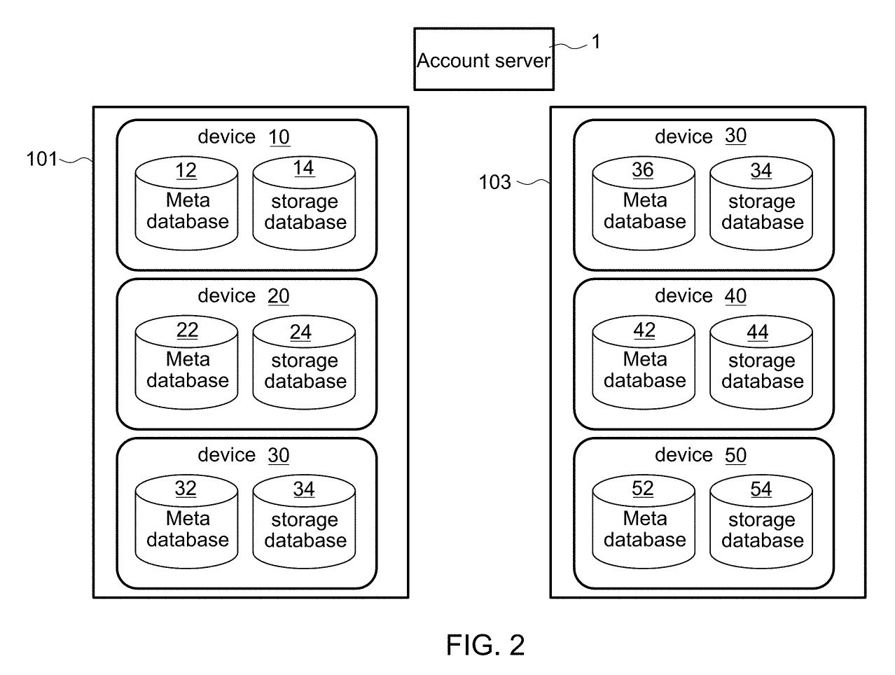

FIG. 2 illustrates communication devices for conducting peer-to-peer file synchronization according to another embodiment of the present disclosure. As shown in FIG. 2, a user 101 may use devices 10, 20, and 30, and another user 103 may use devices 30, 40, and 50. Devices 40 and 50 each have two types of databases. One is a meta database 42 and 52, and the other one is a storage database 44 and 54.

Device 30 is used by both users 101 and 103. Device 30 may be a device shared among family members or colleagues. When user 101 logs in to the account server 1 using device 30 for the first time, meta database 32 will be created on device 30. Meta database 32 includes a plurality of metadata items, which correspond to the files stored in device 30 and owned by user 101. Similarly, when the user 103 logs in the account server 1 using device 30 for the first time, a different meta database 36 will be created on device 30. Meta database 36 includes a plurality of metadata items, which correspond to the files stored in device 30 and owned by user 103. Synchronization of the metadata items across multiple devices can be implemented on an account-specific basis. That is, the metadata items belonging to user 101 will be synchronized across devices 10, 20 and 30, while the metadata items belonging to user 103 will be synchronized across devices 30, 40 and 50.

In device 30, users 101 and 103 share the same storage database 34, and device 30 will have only one copy of the file(s) shared by users 101 and 103 on device 30 in order to save storage space. Nevertheless, user 101 is not allowed to access the files identified by the metadata items stored in meta database 36. Similarly, user 103 is not allowed to access the files identified by the metadata items stored in meta database 32.

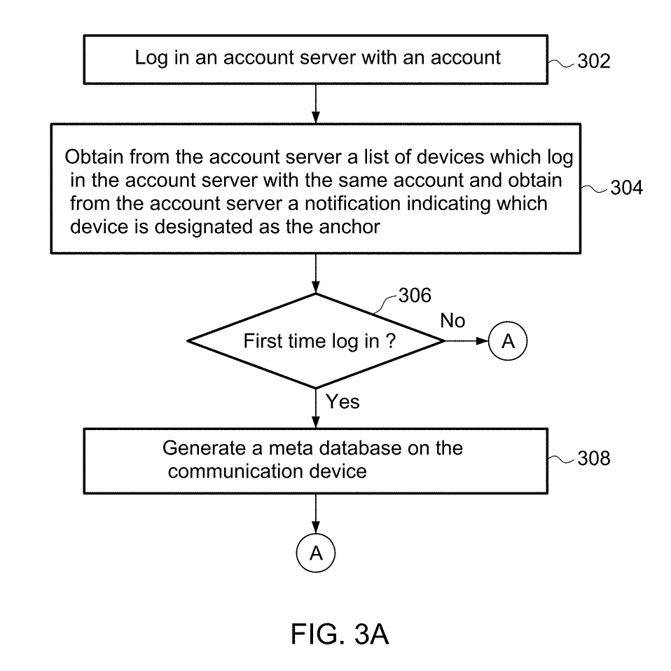

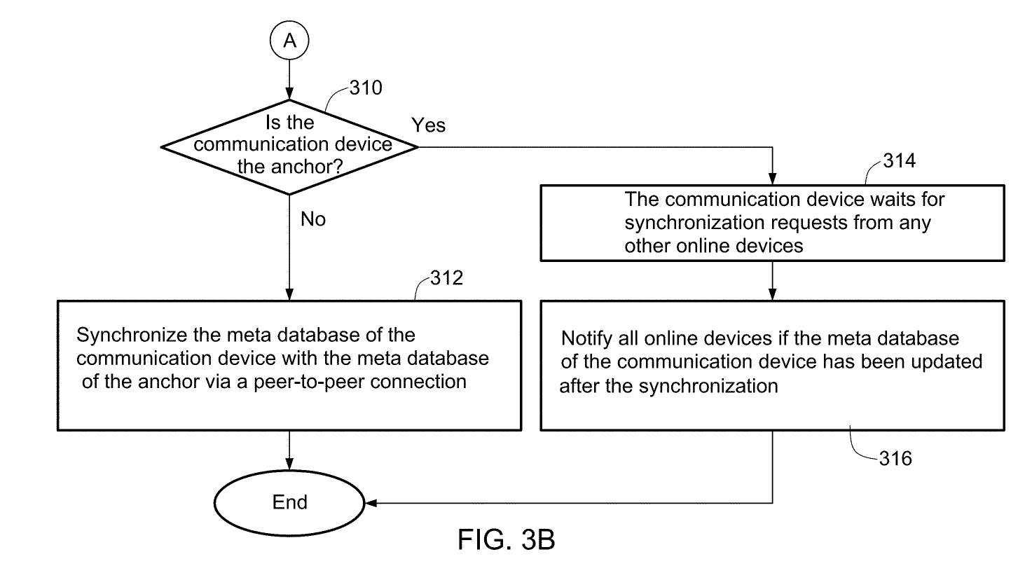

FIGS. 3A and 3B illustrate a flow chart of a method implemented on a communication device for conducting peer-to-peer file synchronization according to another embodiment of the present disclosure. Referring to FIG. 3A, at step 302, a user logs in to an account server via a communication device using his/her account and, in the meantime, the communication device generates a unique ID code and then transmits the unique ID code and the account information to the account server for authentication. After the authentication, the account server will record a binding relationship between the communication device and the user account.

At step 304, the communication device will receive a list from the account server indicating the other devices logged in with the same user account (hereinafter the “online devices”). In the meantime, the account server will also notify the online devices that the communication device is now logged in with the user account. At step 304, the communication device will receive a notification from the account server, indicating which of the online devices is designated as the anchor by the account server.

At step 306, a determination is made regarding whether this is the first login of the user account via the communication device. If yes, go to step 308; if no, go to step 310 in FIG. 3B. At step 308, the communication device will create a meta database and a storage database. The meta database comprises information regarding all the files stored in the communication device and belonging to the user account. The storage database comprises information regarding the actual storage locations of all the files stored in the communication device and belonging to the user account.

Referring to FIG. 3B, at step 310, a determination is made regarding whether the communication device is designated by the account server as the anchor. If yes, go to step 314; if no, go to step 312. At step 312, if the communication device is not the anchor, the communication device will establish a peer-to-peer connection with the anchor and synchronize its meta database with that of the anchor via the peer-to-peer connection. At step 314, if the communication device is the anchor, the communication device will wait for a synchronization request from any other online devices and will be synchronized upon receipt of the request.

At step 316, if the meta database of the communication device has been updated after the synchronization between the communication device and one of the online devices, the communication device will notify the other online devices of the update. Therefore, all the other online devices will initiate another meta database synchronization process with the communication device (i.e., the anchor).

A black box concept is introduced in the present disclosure. The black box used in the present disclosure is a network-enabled device that is configured to maintain a copy of all the files belonging to a user. The black box serves as a backup server and is usually a device that has a big storage space and 24-hour high-speed network connection.

The black box may be a dedicated computing device or a personal computer with an application installed thereon. In other words, the black box may be a network-enabled cell phone, network-enabled gaming device, a network-enabled TV set-top box, a network-enabled PDA, a network-enabled media player, or any other network-enabled device. The black box can be implemented by various types of devices with a particular application installed thereon. The only difference between the black box and the other devices owned by the user may lie in the parameters or flags set by the application.

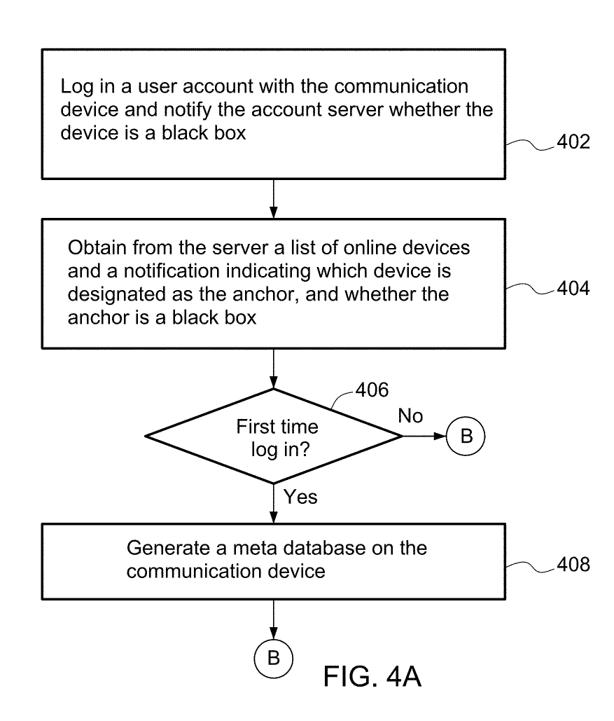

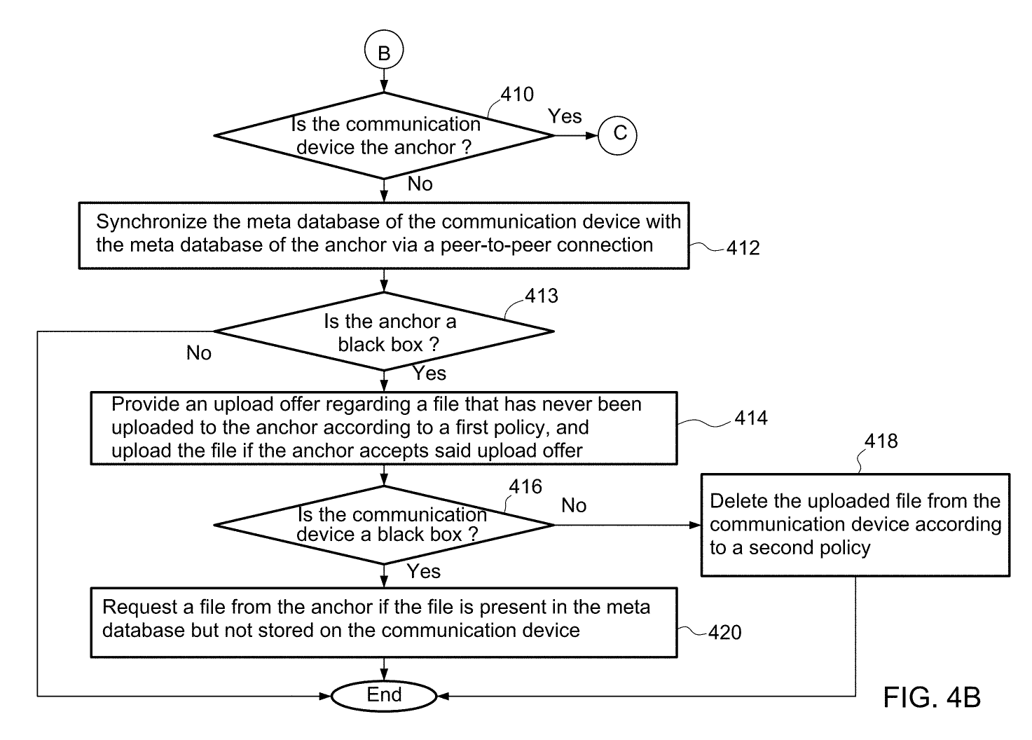

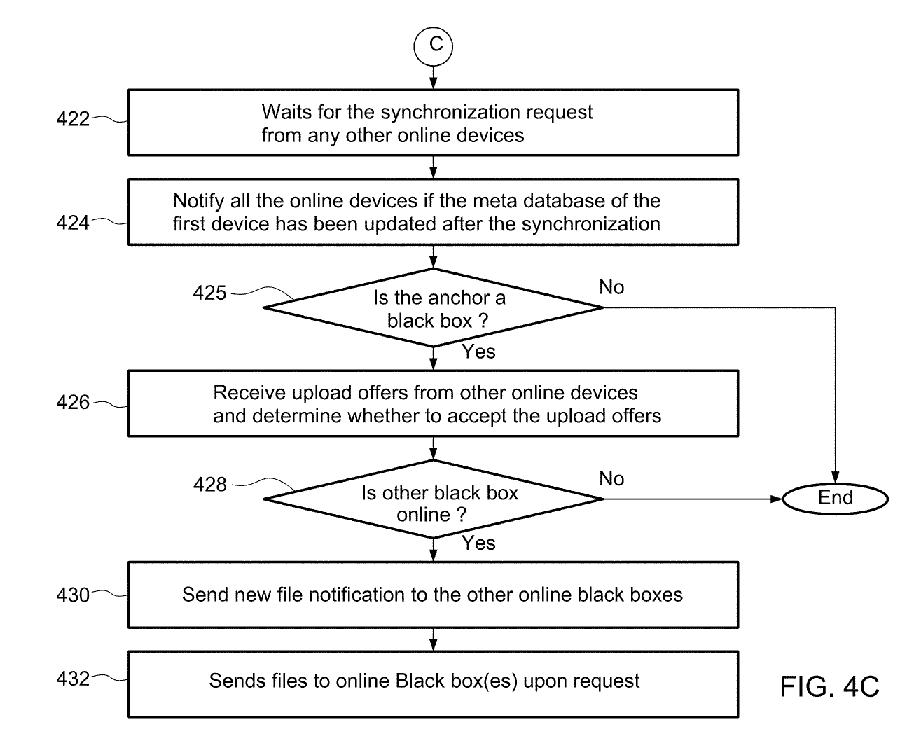

FIGS. 4A-4C illustrate a flow chart of a method implemented on a communication device for conducting peer-to-peer file synchronization according to another embodiment of the present disclosure. In the flow chart, some of the devices owned by the user are black boxes. Before synchronization, the user creates a user account on an account server. All devices owned by the user may share their metadata items or files after the user logs in to the account server. Referring to FIG. 4A, at step 402, the user logs in the user account via a communication device and will notify the account server whether the communication device is a black box, in the meantime, the communication device generates a unique ID code and then transmits the unique ID code and the account information to the account server for authentication. After the authentication, the account server will record a binding relationship between the communication device and the user account.

At step 404, the communication device will receive a list of online devices from the account server. The account server will also notify the other devices that the communication device is now logged in with the user account. At step 404, the communication device will also receive a notification from the account server, indicating which of the online devices is designated as the anchor by the account server and whether the anchor is a black box.

At step 406, a determination is made regarding whether this is the first login of the user account via the communication device. If yes, go to step 408; if no, go to step 410 in FIG. 4B. At step 408, the first device will create a meta database. The meta database comprises information regarding all the files belonging to the user account. The storage database comprises information regarding the actual storage locations of all the files belonging to the user account.

Now referring to FIG. 4B, at step 410, a determination is made regarding whether the communication device is designated by the account server as the anchor. If yes, go to step 422 in FIG. 4C; if no, go to step 412. At step 412, given that the communication device is not the anchor, it will establish a peer-to-peer connection with the anchor and synchronize its meta database with that of the anchor via the peer-to-peer connection.

At step 413, a determination is made regarding whether the anchor is a black box. If yes, go to step 414 in FIG. 4C; if no, the synchronization process ends. At step 414, since the anchor designated by the account server is a black box, the communication device will provide upload offers regarding files that have never been uploaded to the anchor according to a first policy. The first policy may be set by the user. For example, the user may configure the communication device to provide upload offers to the anchor only when the first device has a WiFi connection. For another example, the user may configure the communication device to provide upload offers during certain time periods, for example, between 2:00 AM and 4:00 AM. For yet another example, the user may configure the communication device to provide upload offers automatically.

According to a preferred embodiment of the present disclosure, an upload offer contains metadata of a file that has never been uploaded to the anchor. The anchor will accept an upload offer if the upload offer is directed to a file not stored in the anchor, or reject an upload offer if the upload offer is directed to a file which has been stored in the anchor. In step 414, the communication device further uploads the file directed in the upload offer to the anchor if the anchor replies that the upload offer is accepted. Otherwise, the communication device would not upload the file directed in the upload offer to the anchor. All the other online devices will also provide upload offers to the anchor if the anchor is a black box. At step 416, given that the communication device is not the anchor, a determination of whether the communication device is a black box is made. If yes, go to step 420; if no, go to step 418.

At step 418, the communication device is not a black box and may, according to a second policy, delete the files uploaded to the anchor from the communication device. The second policy may depend on, for example, the remaining storage space of the communication device, the last access time of the file uploaded at step 414, or whether a black box containing the file uploaded at step 414 is logged in. At step 420, if both the anchor and the communication device are black boxes, the communication device will check whether any files in its meta database are absent from its storage database, and if yes, the communication device will send a request to the anchor for downloading those files.

Now referring to FIG. 4C, at step 422, if the communication device is designated as the anchor at step 410, the communication device will be synchronized upon a synchronization request from one of the other online devices. At step 424, if the meta database of the communication device has been updated after the synchronization between the communication device and one of the online devices, the communication device will notify the other online devices of the update. Therefore, all the other online devices can initiate another meta database synchronization process with the communication device (i.e., the anchor).

At step 425, a determination of whether the anchor is a black box is made. If yes, go to step 426; if no, the synchronization process ends. At step 426, given that the communication device is the anchor as well as a black box, the communication device will wait for upload offers from other online devices. As mentioned above, an upload offer contains metadata of a file that has never been uploaded to the anchor. If the communication device determines that the received upload offer directs to a file that it does not have, the communication device sends a reply accepting such upload offer and waits for the uploading. Otherwise, the communication device sends a reply rejecting such upload offer. At step 428, the communication device performs different operations depending on whether at least one of the other online devices is a black box too. If there is another black box, go to step 430; otherwise, the synchronization process ends. It goes to step 430, if the communication device is the anchor as well as a black box, and there is another black box(s). In this situation, after the communication device receives files uploaded from other online devices, the communication device will notify the other black box(s) that new file(s) is uploaded to the anchor. The other black box(s) may request for the new file(s) from the communication device. At step 432, the anchor sends the new file to another black box upon a request from said another black box. As a result, each black box should have a copy of all the files belonging to the user.

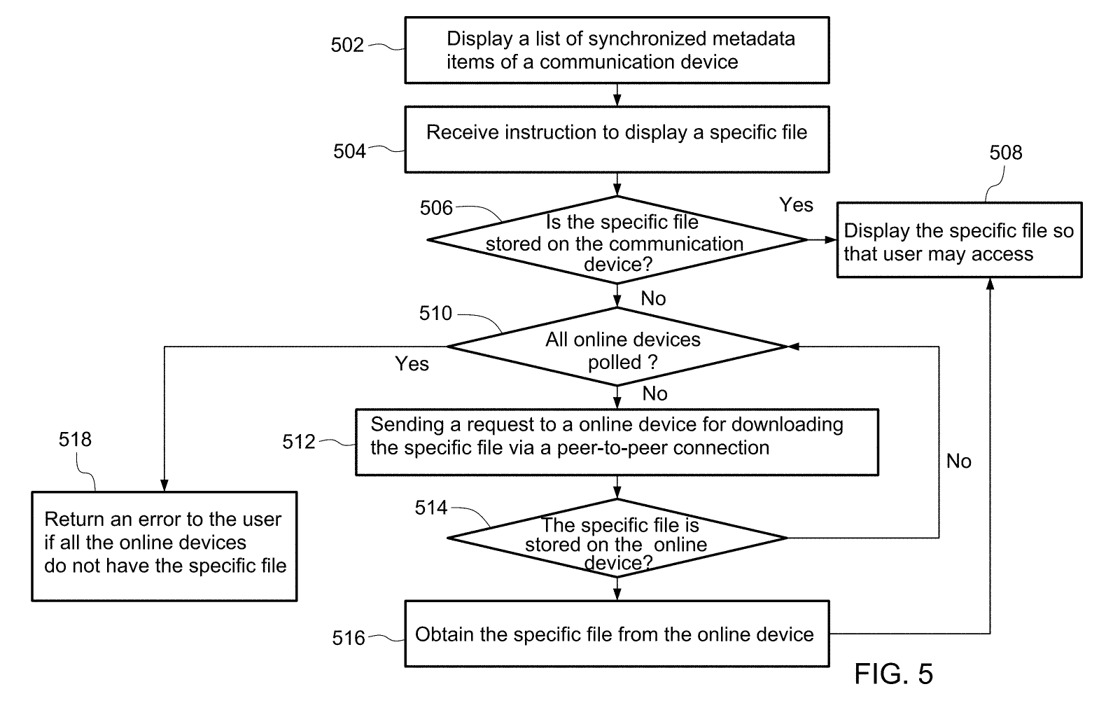

FIG. 5 illustrates a flow chart for displaying and accessing files on a communication device, wherein the files are shared among the devices owned by the user but may or may not be stored in the communication device, which is currently used by the user. At step 502, a list showing the synchronized metadata items is displayed on the communication device. At step 504, the user may instruct the communication device to display a particular file. At step 506, a determination is made regarding whether that file is already stored in the communication device. If yes, that file will be displayed directly at step 508. If no, at steps 510, 512 and 514, the communication device will send a request to all the online devices, one after another, for confirmation on whether that file is stored in any of the online devices. At step 514, the online device receiving the request will reply whether it has the requested file.

If that file is stored in one of the online devices, the communication device will download it from the relevant online device (step 516). Then that file will be displayed directly at step 508. On the other hand, if the online device receiving a request replies that it does not have the requested file, go back to step 510. At step 510, a determination is made regarding whether all the online devices have received a request. If no, the communication device will send a request to another online device for downloading the requested file (step 512). If all the online devices have replied that they do not have the requested file, the communication device will show an error message to the user at step 518.

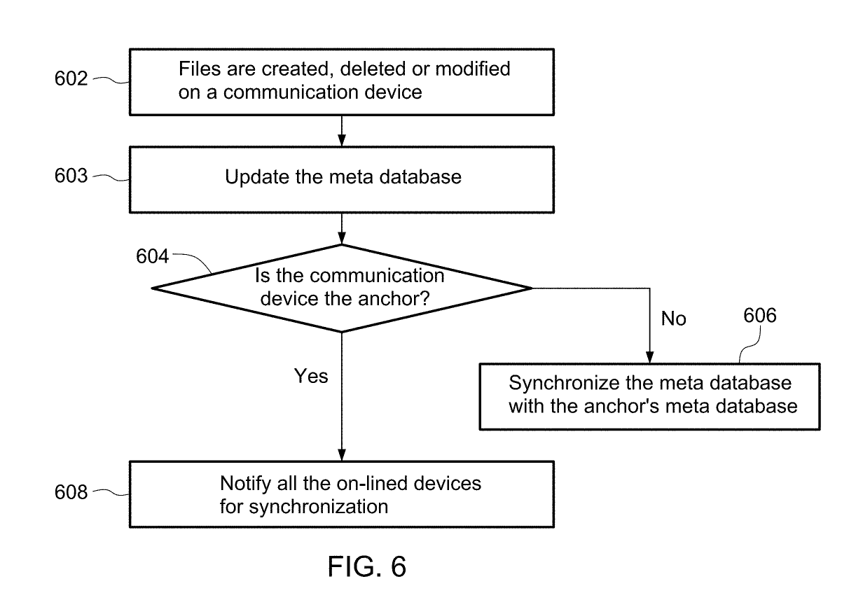

FIG. 6 illustrates a flow chart of file synchronization initiated in response to changes in the files stored in a communication device, according to an embodiment of the present disclosure. The flow chart shows the synchronization steps that will take place when a new file is created on the communication device, or when an existing file in the communication device has been modified or deleted. The communication device may be, for example, any one of the devices 10, 20 and 30 owned by user 101 in FIG. 1. At step 602, a new file is created on the communication device, or an existing file in the communication file has been modified or deleted. The meta database of the communication device is updated accordingly at step 603. At step 604, the communication device performs different operations, depending on whether it is designated as the anchor by the account server.

If the communication device is not the anchor, the communication device will, at step 606, establish a peer-to-peer connection with the anchor and synchronize its meta database with that of the anchor. On the other hand, if the communication device is the anchor, the communication device will, at step 608, notify all the other online devices of the update; all the other online devices may then initiate a synchronization process with the communication device.

### P2P Connections

In the present disclosure, a P2P connection between devices may be established using, for example, a technique known as Interactive Connectivity Establishment (ICE). Under the ICE technique, a suitable connection can be established between devices according the network environments of the devices. For example, a direct connection can be established between two devices if they are within the same Local Area Network (LAN). Otherwise, a connection can be established using a firewall penetration algorithm. A protocol known as Session Traversal Utilities for NAT (STUN) can be used in establishing P2P connection with a firewall penetration algorithm.

If P2P connection cannot be established using a firewall penetration algorithm, a connection can be established using a bridge. A protocol called Traversal Using Relay NAT (TURN) can be used to establish a bridge between two devices. The above examples are illustrative rather than exhaustive; the P2P connection in the present disclosure is not limited to the above examples. Persons skilled in the art can use other techniques to establish the P2P connection mentioned in the present disclosure.

### Anchor Designation

In the discussions above, the designation of the anchor is dynamically made by the account server according to the statuses of the online devices or the user's preference. In an embodiment, a device with powerful processing capability and/or a large network bandwidth has higher priority of being selected as the anchor. In another embodiment, the user may manually arrange the priority of the devices as the anchor. In yet another embodiment, if the online devices include one or more black boxes, the one or more black boxes will have higher priority of being selected as the anchor.

When a communication device logs in the account server, the account server determines whether the anchor should be changed according to the above-mentioned policy. If no, only the communication device newly logging in will be informed of the anchor, otherwise all communication logging in with the same account would be informed of the new anchor. Furthermore, when any communication logs out or disconnects, such information would be broadcasted to all communication devices online. In the meanwhile, the account server will be triggered to determine whether a new anchor should be designated and inform all communication devices if necessary.

### File Transfer & Device-Optimized File

In the present disclosure, before uploading or downloading a file, the file may be adjusted according to a device profile. The concept of file optimization is introduced. For example, if a first device cannot open a Microsoft Word file stored in a second device, the second device may send the Microsoft Word file in PDF format to the first device. For another example, if a first device requests a picture from a second device, the second device may adjust the resolution of the picture according to the screen resolution of the first device before sending the picture to the first device. Furthermore, if a synchronization is initiated by the modification of a file in the second device, the second device may transmit the entire file or merely the modified portion of the file to the first device.

### User Scenarios

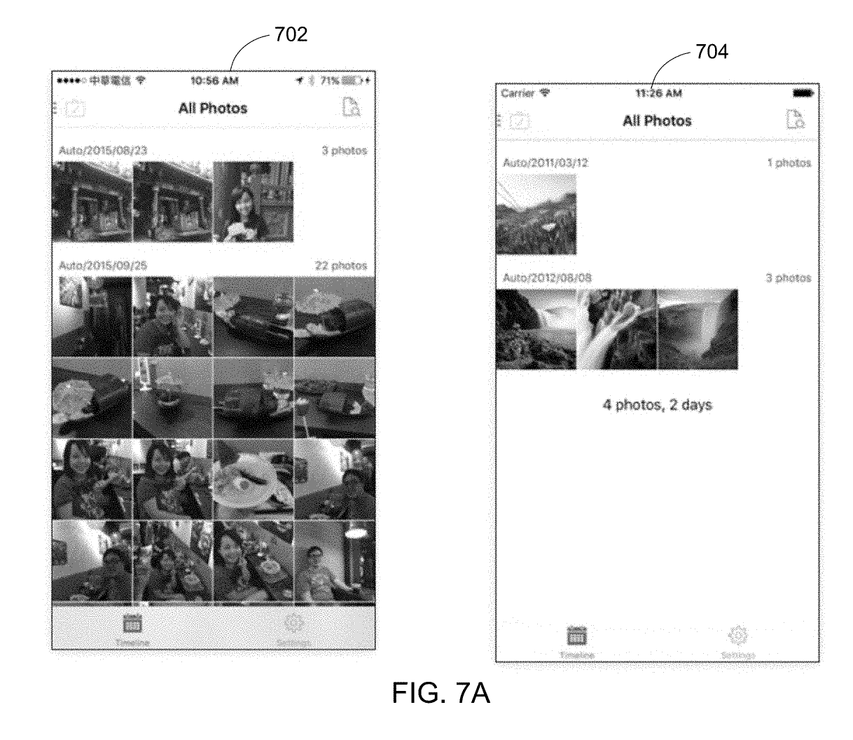

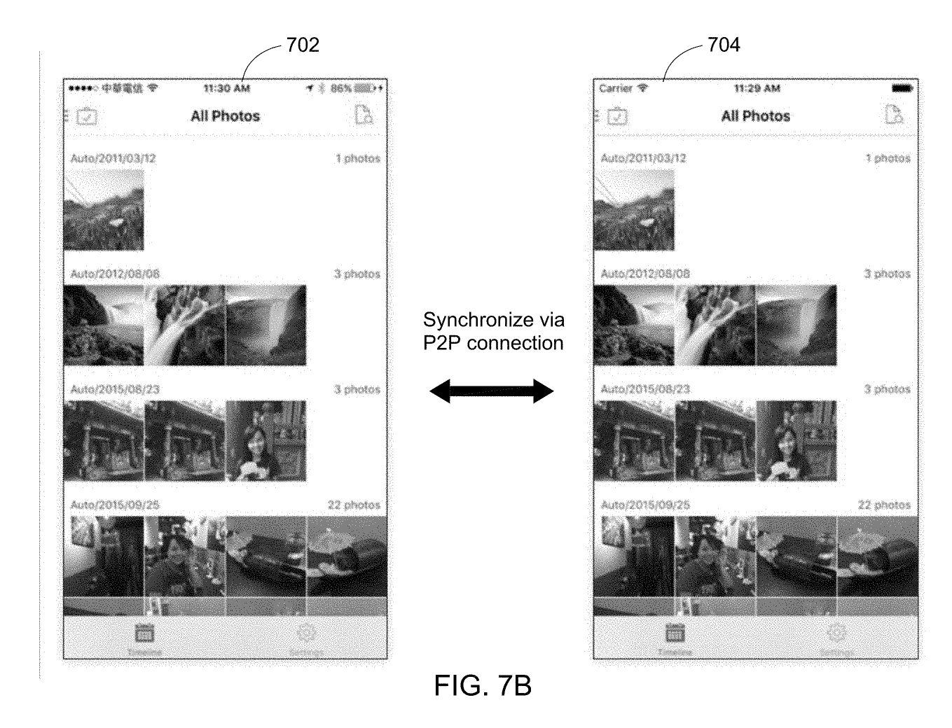

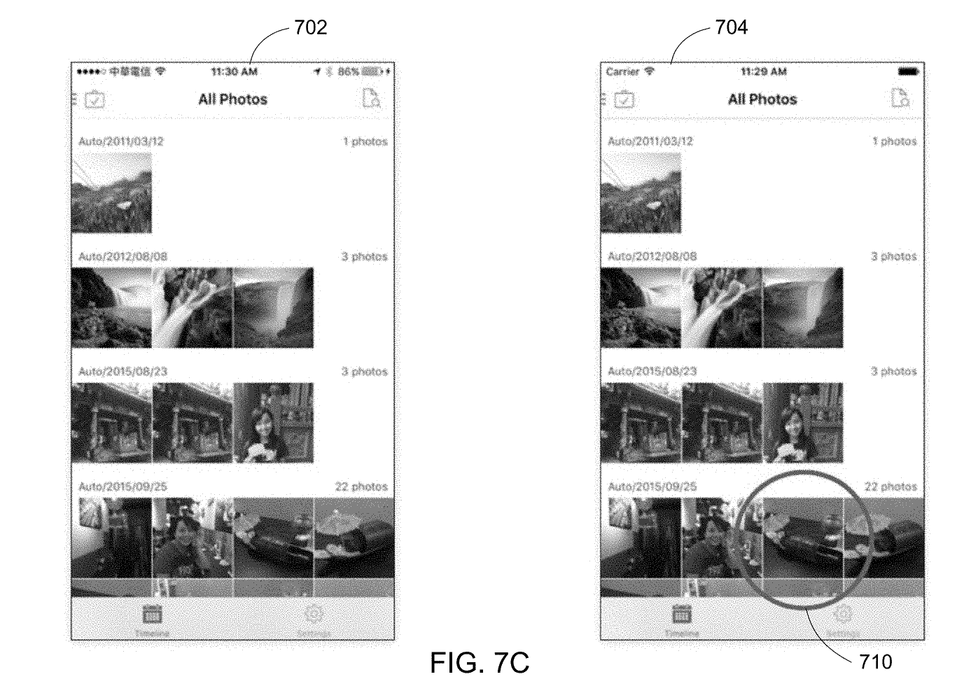

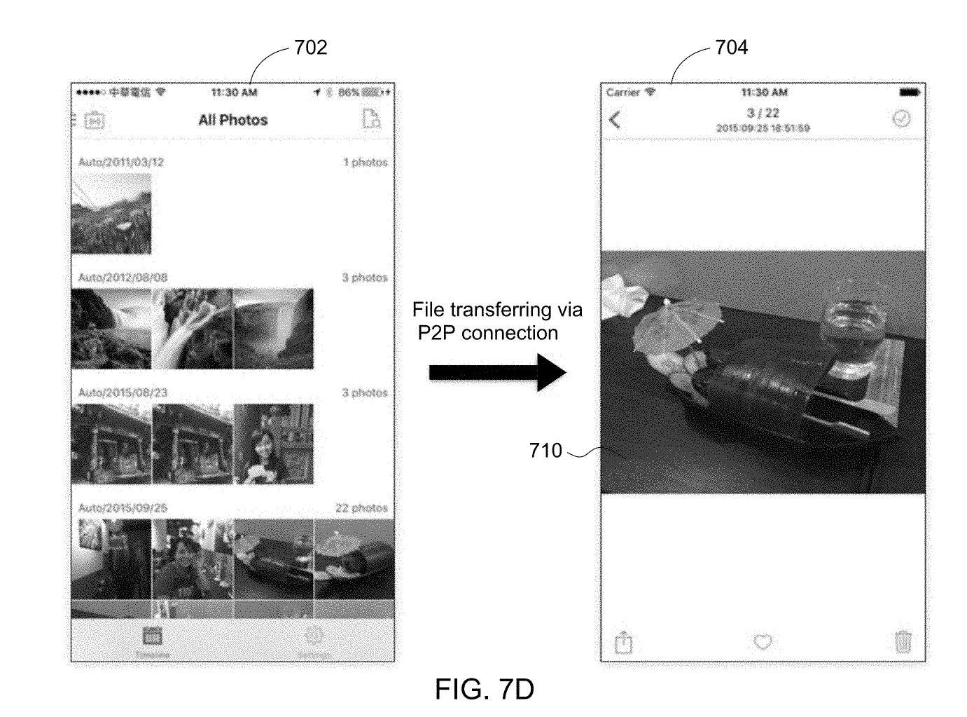

FIGS. 7A-7D illustrate a preferred embodiment of peer-to-peer file synchronization across multiple devices through a photo album application. The photo album application is capable of maintaining a single virtual album for all the devices. As shown in FIG. 7A, before the P2P synchronization, the photo album application on device 702 displays only the files stored in device 702, and the album application in device 704 displays only the files stored in device 704.

In FIG. 7B, after the meta databases of devices 702 and 704 are synchronized using the methods disclosed herein, devices 702 and 704 would be able to display thumbnail pictures of all the files stored in either of devices 702 and 704 to the user since the meta databases of devices 702 and 704 have been synchronized. In other words, the user would be able to see the same file list on each device. In FIG. 7C, the user attempts to access a particular file 710 in device 704, but the file 710 is stored in device 702 instead of device 704. In this situation, according to the methods disclosed herein, device 704 would be able to download the file 710 from device 702 via a peer-to-peer connection with device 702 as shown in FIG. 5. Furthermore, device 702 may adjust file 710 according to the device profile of device 704, such as adjusting the resolution of the image of file 710 according the resolution of the display of device 704, and then send the adjusted file to device 704.

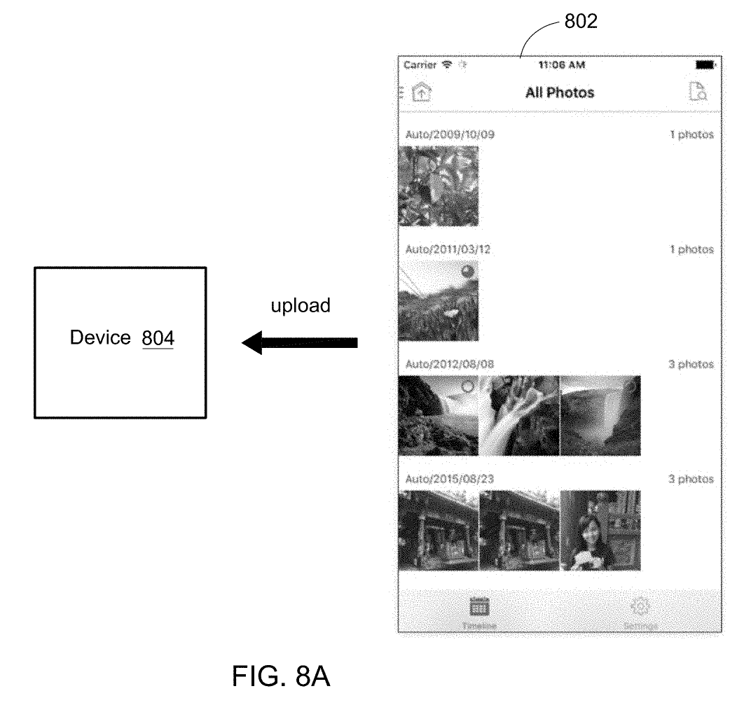

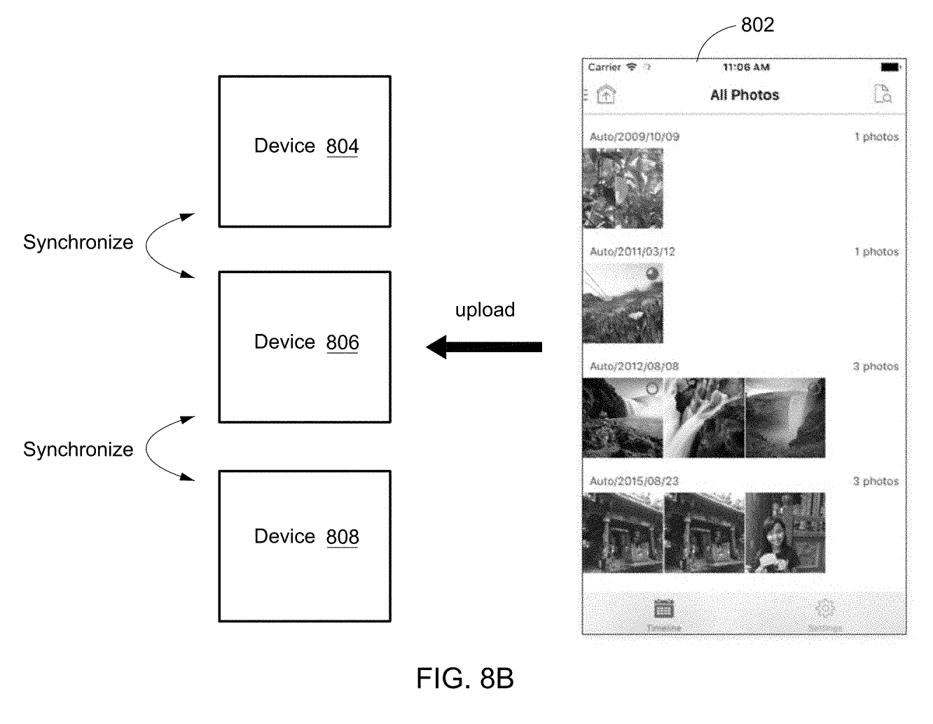

FIGS. 8A and 8B illustrate a preferred embodiment of peer-to-peer file synchronization across multiple devices wherein one of the devices is a black box. As shown in FIG. 8A, devices 802 and 804 are both online devices, and device 804 is a black box and is also the anchor designated by the account server. In this situation, device 802 will provide upload offers to device 804 after synchronization. Device 804 will check whether to accept any one of the upload offers from device 802. If device 804 already has the files indicated in any of the upload offers, it will deny that upload offer and accept the upload offers for the files that it does not have. As a result, device 804 will have a copy of all the files stored in device 802.

FIG. 8B shows file synchronization across four devices via a photo album application according to a preferred embodiment of the present disclosure, wherein one or more of the devices are black boxes. As shown in FIG. 8B, devices 802, 804, 806 and 808 are online devices. Devices 804, 806 and 808 are black boxes, and device 806 is designated as the anchor by the account server. Device 802 will provide upload offers to device 806 only. After device 806 accepts files uploaded from device 802 (which means device 806 now comprises some new files), device 806 will notify devices 804 and 808. Devices 804 and 808 will be able to download any files that are not stored in them from device 806.

The method disclosed in the present disclosure allows anchor-based synchronization across devices. The meta database of the anchor will be synchronized with the meta databases of all the other online devices. The anchor is dynamically selected from all the online devices by an account server. The selection of the anchor may depend upon the connection status, computing capability, or bandwidth of these online devices or the user's settings. File synchronization across devices is done through peer-to-peer connection without the participation of the account server. This synchronization method provides much better privacy and security protection.

Also, it is unnecessary to have an account server with a large storage space since the files are stored in the user's devices. The user can select a device as the black box, which maintains a copy of all files belonging to him/her. The user can easily establish his own “backup server” (i.e. the black box).

The foregoing outlines features of several embodiments so that those skilled in the art may better understand the aspects of the present disclosure. Those skilled in the art should appreciate that they may readily use the present disclosure as a basis for designing or modifying other processes and structures for carrying out the same purposes and/or achieving the same advantages of the embodiments introduced herein. Those skilled in the art should also realize that such equivalent constructions do not depart from the spirit and scope of the present disclosure, and that they may make various changes, substitutions, and alterations herein without departing from the spirit and scope of the present disclosure.

What is claimed is:

1. A method operating on a communication device for synchronizing data stored in the communication device with data stored in at least one device, the method comprising:
logging in a server with a user account;
generating at least one metadata item for at least one file stored in the communication device, respectively;
obtaining from the server a list of the at least one device which logs in the server with the user account;
obtaining from the server a notification indicating an anchor among the communication device and the at least one device;
exchanging data with each of the at least one device through a peer-to-peer connection, while the communication device is designated as the anchor, so as to ensure that the communication device and the at least one device share the same metadata items; and
exchanging data with the anchor through a peer-to-peer connection, while one of the at least one device is designated as the anchor, so as to ensure that the communication device and the anchor share the same metadata items.

2. The method of claim 1, wherein each metadata item comprises a hash value and/or information for the file corresponding to said metadata item.

3. The method of claim 1, wherein while the anchor is among the at least one device, the step of exchanging data comprises synchronizing a first database of metadata items of the communication device with a second database of metadata items of the anchor.

4. The method of claim 3, wherein exchanging data between the communication device and the at least one device further comprises providing an upload offer of file to the anchor.

5. The method of claim 4, further comprising:
after transmitting a specific file specified in the upload offer to the anchor, deleting the specific file from the communication device.

6. The method of claim 1, further comprising:
when an user accesses a specific file, which corresponds to a specific metadata item and is not stored in the communication device, sending a request comprising information in the specific metadata item to one of the at least one device for downloading the specific file; and
receiving and storing the specific file.

7. The method of claim 3, further comprising: if a metadata item stored in the communication device corresponds to a file which is not stored in the communication device, automatically downloading the file from one of the at least one device.

8. The method of claim 1, further comprising:
receiving a request for a specific file from one of the at least one device;
generating a device-optimized file of the specific file by adjusting the specific file according to a device profile of the device; and
sending the device-optimized file to the device.

9. The method of claim 1, further comprising:
updating a database of the at least one metadata item in the communication device after creating, deleting or modifying a specific file stored in the communication device; and
triggering the step of exchanging data.

10. The method of claim 1, wherein while the communication device is designated as the anchor, the step of exchanging data comprises after a first database of metadata items of the communication device being synchronized with a second database of metadata items of one of the at least one device, sending a notification to the rest of the at least one device for updating databases of the rest of the at least one device.

11. The method of claim 1, wherein the anchor is designated by the server according to bandwidth or process capability of each of the communication device and the at least one device or a manual setting.

12. A machine-readable medium storing thereon a program for implementing the method of claim 1 when the program is executed by a processor of a communication device.
